(19) United States
(12) Patent Application Publication
(10) Pub. No.: US 2013/0213826 A1
(43) Pub. Date: Aug. 22, 2013

(54) PORTABLE ELECTRONIC DEVICE HOLDER

(71) Applicant: Christopher David Partridge, Burlington (CA)

(72) Inventor: Christopher David Partridge, Burlington (CA)

(21) Appl. No.: 13/818,667

(22) PCT Filed: Sep. 23, 2011
(86) PCT No.: PCT/CA2011/001065

§ 371 Date: Feb. 23, 2013

Related U.S. Application Data
(60) Provisional application No. 61/455,917, filed on Oct. 29, 2010.

(51) Int. Cl. A45C 11/00; F16M 13/04; A45F 5/02

(52) U.S. Cl. CPC A45C 11/00; A45F 5/02; F16M 13/04
USPC 206/45.24; 24/305; 24/499

(57) ABSTRACT

A portable electronic device holder consisting essentially of a cradle to which a dual-function pivotable clip is mounted. The cradle is structured as a backbone panel with bottom and top bracing sections adapted to receive and retain the respective end of a device to be held, either or both sections incorporating resilient means by which to securely clamp the device once seated therein. The pivotable clip is constructed of resilient wire formed as an open frame with transversely opposite ends, serving as bearing journals that are mounted in axially offset channels of a clip bearing, thereby inflicting elastic structural deformation on the clip. A biasing torque results, urging the clip towards the backbone panel when below a critical angle, thereby to serve as a clasp, and away from it when above the critical angle, thereby to readily assume an orientation at which to serve as a prop.

### TECHNICAL FIELD

The present invention relates generally to carrying holders or cases for handheld electronic devices and particularly to a carrying holder for a portable electronic device incorporating an electronic visual display, which may be clipped to a garment edge or propped semi-vertically on a horizontal surface.

### BACKGROUND ART

The commercial introduction of the cellular telephone and the personal digital assistant (PDA), in the mid-eighties, and portable media players, in the nineties, has led to an exponential global proliferation of such and similar devices. During the past two decades and particularly once the functionalities of cell phones, PDAs, and portable media players have been combined into what is now known as the smartphone, the popularity of these devices has reached a point where in most parts of the world they are considered indispensable. Indeed, millions of people around the world carry smartphones with them for many hours daily.

Inevitably, a need soon arose for a means by which to secure smartphones and standalone cell phones, media players, and PDAs (hereafter and in the appended claims collectively termed “portable electronic devices”, or “PEDs”) to a person's clothing, or to a carried bag or briefcase to prevent loss or damage. To facilitate the secure carriage of PEDs and to protect these devices from surface and impact damage, carrying cases and cradles of various designs (hereafter and in the appended claims termed generally “PED holders”) have been devised. In many designs an attachment clip is incorporated or integrated with the PED holder by which it may be attached to a belt, a pocket, or another article of clothing, or to other thin-walled surfaces such as a compartment divider in a briefcase or a shoulder bag.

Consequent to the advent of electronic visual displays in PEDs, a further need arose for a means by which to prop PEDs inclined on a desktop or a countertop for convenient, hands-free viewing. In recognition of this need, PED holders have been designed to incorporate one or more swivable arms or plates which may be pivoted to a predetermined fixed or adjustable orientation to serve as a prop upon which the PED holder may rest inclined.

PED holders featuring dual-function attachment clips adapted to serve as props have also been devised addressing the two aforesaid needs with an economy of parts. Two configurations are found in the prior art—the first configuration employs a clasping arm or plate that is hinged at its top to a base member which is fixed to the rear of the PED holder and against which, through a leaf- or a torsion-spring, it is resiliently biased. A swivable strut deployable in a single or in several orientations is employed in this configuration to brace the clasping arm at a fixed or adjustable propping orientation.

This configuration is shown in patent US7513472B2 (Yang, 2009). An arrangement similar in principle to Yang's is disclosed in patent application US20110031287A1 (Gette and Reeb, 2011). The enhanced functionality afforded by the adjustability of the clasping arm's orientation entails the added complexity—and hence cost—of the swivable strut and associated linkages and catchments. Patent U.S. Pat. No. 6,125,513A (Cheraso and Jackson, 2000) teaches the use of a buckling leaf spring with a bidirectional bias to urge a clasping member to either a close, clasping position, when the angular displacement of the clasping member is below a predetermined threshold, or to an open, prop position, when the angular displacement of the clasping member is beyond that threshold. Though simpler in construction than the former two, this patent still requires a sizeable leaf-spring, sufficiently long to manifest the specified behaviour.

The second configuration employs a clasp which is hinged at its top to the rear of the PED holder, and which may be pivoted unitarily with respect thereto, either freely, or to discrete angular displacements within a predetermined range. Two types of clasps are known in the art: the first type is structured simply as a generally U-shaped unit from resilient material, so that a clamping force is exerted on any object inserted therewithin—patents U.S. Pat. No. 7,110,802B1 (Kim and Yang, 2006) and US20080156836A1 (Wadsworth and Fuge, 2008) exemplify such clasp units. The second type is structured as an assembly comprising a base member to which a clamping member is hinged and towards which—through a leaf—or a torsion-spring—it is resiliently biased. A clasp assembly of this double-hinge type is taught in patents U.S. Pat. No. 5,385,282A (Chen, 1995) and U.S. Pat. No. 7,110,802B1 (Kim and Yang, 2006). The former, unitary clasp type, being of fixed geometry, presents a limitation on the thickness of the object clasped therein; it is only effective in retaining objects thinner than the gap it defines (e.g. a belt) and in clasping objects slightly thicker than that gap. If formed of resilient plastic material it is prone to breakage when forced over an object significantly thicker than the gap it defines, or when it is removed from the clasped object uncarefully. If formed of resilient metal, such actions may subject the clasp to permanent plastic deformation. The latter clasp type suffers from the complexity—and therefore, again, increased cost of manufacturing—of the multi-part double-hinge design.

The use of a resilient, open, wire frame as a clip, where the biasing force results from the elastic structural deformation of the frame when pivoted about transverse, axially offset journal sections thereof, as proposed by the present invention, is taught in patent US005379492A (Glesser, 1995) and patent U.S. Pat. No. 7,325,836B2 (Eckhardt, 2008). In the former patent, the wire frame clip undergoes torsional distortion about a lateral axis when pivoted away from its neutral orientation, which produces a biasing torque that is used in this patent to secure a hand-held article to a pocket. In the latter patent, a wire frame clasp is used, which sustains a more complex deformation (as in the present invention)—again, producing a biasing torque that is used in this patent to clasp a stack of paper on an easel. This patent recognizes, though makes no particular use of, the bi-directional bias property of a resilient wire frame clip, a characteristic utilized in the present invention.

### SUMMARY OF INVENTION

In view of the prior art, the present invention is set to address several objects, as follows:

It is the principal object of the present invention to provide a PED holder, adapted to accommodate and securely, but releasably brace a PED of a specific form and dimensionality while allowing unobstructed viewing of its electronic visual display, operation of at least some of its controls, and access to at least some of its connection ports.

A second, more specific object of the present invention is to provide a means by which a PED holder may be clasped to a garment edge or to any other such thin-walled object, comprising a minimum of parts.

A third, further specific object of the present invention is to adapt said clasping means of the aforesaid second object to serve as a prop upon which the PED holder may rest inclined in a vertical or a horizontal orientation on a substantially horizontal surface for convenient, hands-free viewing of its display.

These objects are met in embodiments of the present invention through a number of features, as outlined below.

The first feature of the present invention is a substantially open-sided cradle, formed as a backbone panel with forwardly extending top and bottom trough-like bracing sections which are adapted to receive the respective end of a PED to be held and clamp it therewithin by a resilient means affixed to an interior face thereof.

A second feature of the present invention is the use of a resilient, open wire frame that is hinged to the rear face of the backbone panel in such a manner as to be urged towards abutment with it, clasping any thin-walled object disposed therebetween.

A third feature of the present invention is the utilization of a reversed bias property of the aforesaid resilient wire frame clip, when pivoted beyond a certain threshold, in allowing it to be readily flipped open to a predetermined maximal angular displacement orientation, there to serve as a prop.

### BRIEF DESCRIPTION OF DRAWINGS

Several embodiments of the present invention are described in detail next, with reference to the following illustrations:

FIG. 1—a perspective frontal view, showing the main structure;

FIG. 2—a perspective top view, showing the bottom-mounted leaf spring;

FIG. 3—an isometric view of the leaf-spring in isolation;

FIG. 4—a perspective rear view, depicting the clip in a first, default orientation;

FIG. 5—a perspective frontal view of a first embodiment of the clip bearing;

FIG. 6—a perspective frontal view of a first embodiment of the clip bearing showing the range-limiting boss;

FIG. 7—an orthographic rear view, depicting the clip in the default orientation;

FIG. 8—an orthographic side view, depicting the clip in the default position;

FIG. 9—a perspective rear view, depicting the clip in a second, prop orientation;

FIG. 10—an orthographic rear view, depicting the clip in the prop orientation;

FIG. 11—an orthographic side view, depicting the clip in the prop orientation;

FIG. 12—an isometric view of the wire frame clip in isolation;

FIG. 13—an orthographic front view, depicting the wire frame clip in isolation;

FIG. 14—an orthographic side view, depicting the wire frame clip in isolation;

FIG. 15—a schematic diagram depicting an orthographic side view of the bi-directional angular displacement geometry;

FIG. 16—a perspective frontal view of the second embodiment of the clip bearing;

FIG. 17—a perspective rear view of the second embodiment of the clip bearing;

FIG. 18—a perspective frontal view of the second embodiment of the clip bearing with the wire frame clip in the default orientation;

FIG. 19—a perspective frontal view of the second embodiment of the clip bearing with the wire frame clip in the prop orientation;

FIG. 20—a perspective rear view of the third embodiment of the clip bearing;

FIG. 21—a perspective frontal view of the third embodiment of the clip bearing;

FIG. 22—a perspective side view of the third embodiment of the clip bearing with the corresponding second embodiment of the wire frame clip in the default orientation;

FIG. 23—a perspective view of the second embodiment of the wire frame clip;

FIG. 24—a perspective side view of the third embodiment of the clip bearing with the corresponding second embodiment of the wire frame clip in the prop orientation;

It is to better elucidate the invention by way of example that the following description and the accompanying illustrations are provided, and not in any way to narrow its purview strictly to the embodiments exemplified.

### MODES FOR CARRYING OUT THE INVENTION

A first embodiment of the PED holder set forth by the present invention is illustrated in the accompanying figures and is denoted generally by reference numeral 1.

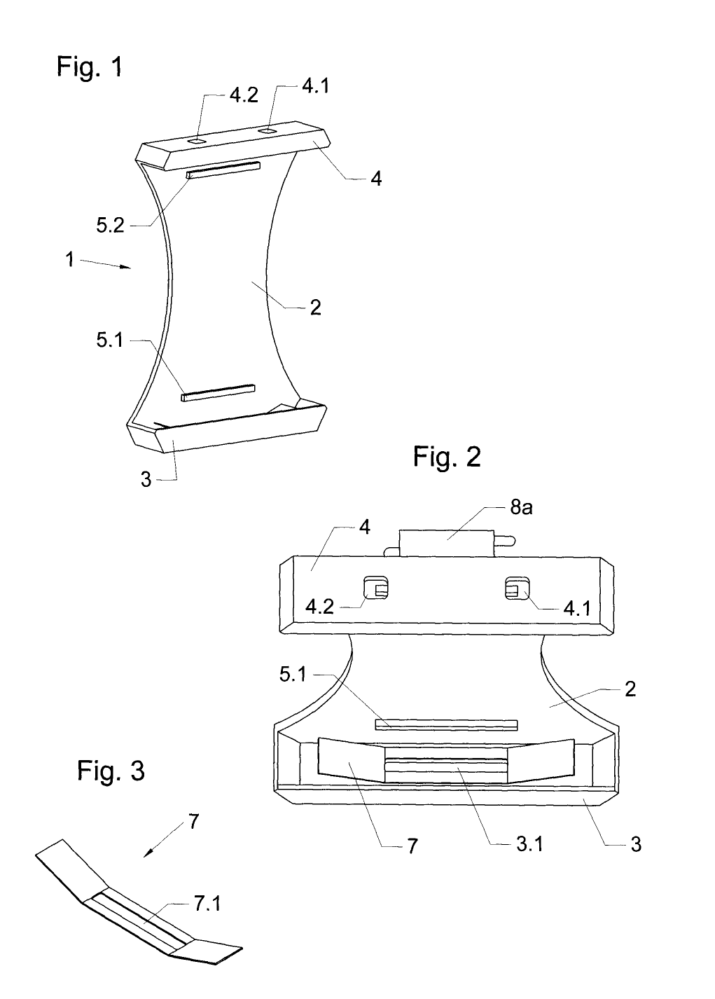

Referring to FIG. 1, PED holder 1 is comprised of backbone panel 2, from whose front face rise spacers 5.1 and 5.2—shallow protuberances which offset the seating position of a held PED from backbone panel 2, thereby to accommodate buttons which may be protruding therefrom when it is lodged facing said panel. A PED may be carried in this reversed manner in PED holder 1 in order to protect its display surface.

Extending forward from the bottom and top ends of backbone panel 2 are trough-like bracing sections 3 and 4, respectively, hereafter and in the appended claims termed “troughs”. In preferred embodiments, troughs 3 and 4 are advantageously formed with inwardly sloping interior wall faces to help guide the respective end of a PED to be held towards a seated position.

Affixed to the interior bottom face of trough 3, as best seen in FIG. 2, is leaf spring 7, depicted in isolation in FIG. 3. In preferred embodiments, leaf spring 7 is adapted with an elongated opening in its base, which corresponds to dock opening 3.1 in trough 3, to allow a dock connector access to the PED. In alternative embodiments, one or more lengths of a high-resilience foam strip or an elastomer strip or tubing is employed in lieu of leaf spring 7.

Trough 3 is dimensioned in relation to trough 4 to allow the lodging and release of a PED in and from PED holder 1 in the manner described next.

The bottom end of a PED to be held is brought into trough 3, bearing down upon leaf spring 7 until the top of said PED clears the anterior wall of trough 4 at which point said PED is righted parallel to backbone panel 2, abutting spacers 5.1 and 5.2. At this point said PED is allowed to rise by the action of leaf spring 7, and assumes a position where its top abuts the interior wall faces of trough 4 and its bottom is held frictionally by leaf spring 7 within the confines of trough 3.

In an alternative embodiment, backbone panel 2 is made of polymeric material and is formed with shallow, cupped flanges extending forwardly and substantially perpendicularly from at least two opposite edges thereof, which flanges resiliently brace a PED lodged therein.

In preferred embodiments, top trough 4 is formed with openings 4.1 and 4.2 to allow access to controls and connection ports positioned atop a held PED.

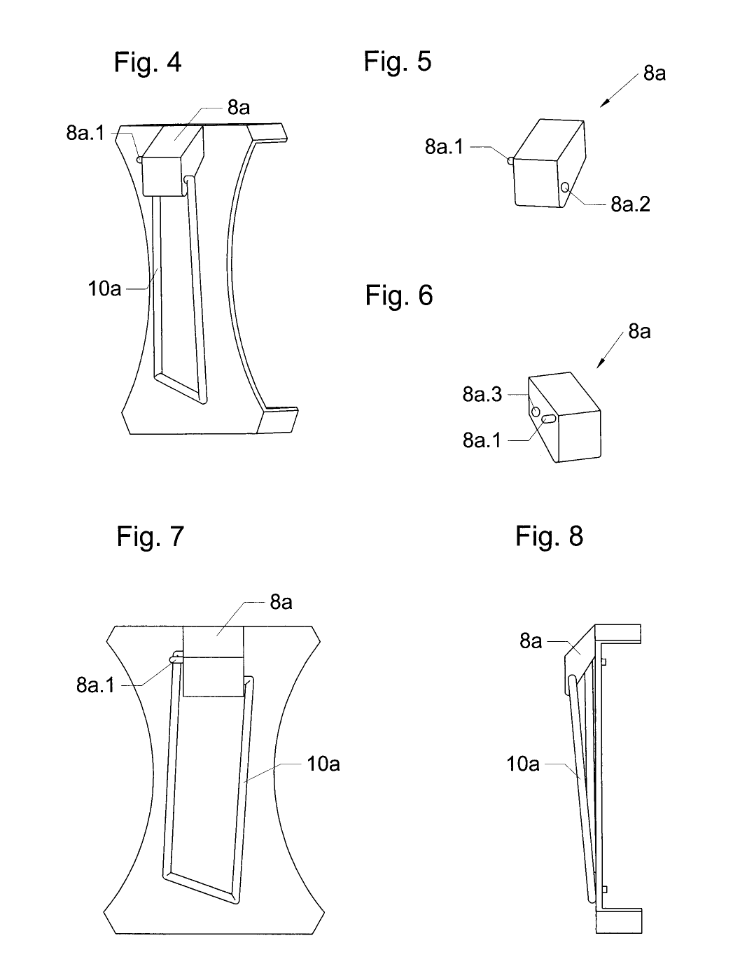

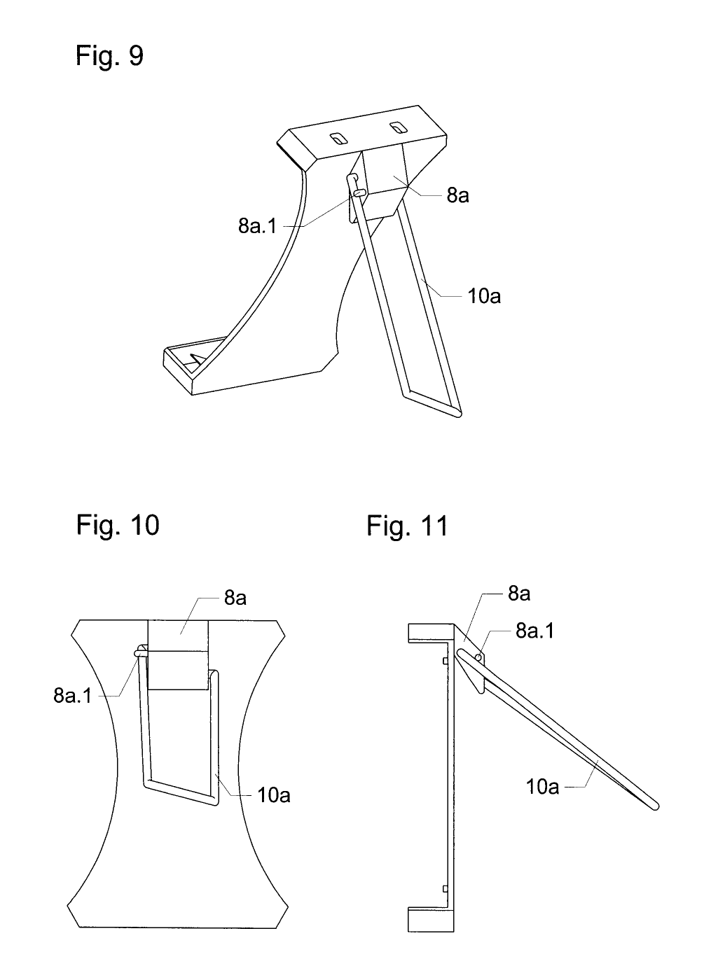

Mounted to or integrated with the top part of the rear face of backbone panel 2, as seen in FIG. 4, is clip bearing 8a, depicted in isolation in FIG. 5 and FIG. 6. Clip bearing 8a is formed or bored with two axially offset, parallel journal channels 8a.2 and 8a.3, extending oppositely and transversely from the side walls thereof, in which the respective journal sections of clip 10a (described hereinafter) are pivotally borne. Clip bearing 8a is formed or adapted further with a range-limiting boss 8a.1, seen clearly in FIG. 6-7 and depicted functionally in FIG. 9-11, which defines the maximum angular displacement clip 10a may assume.

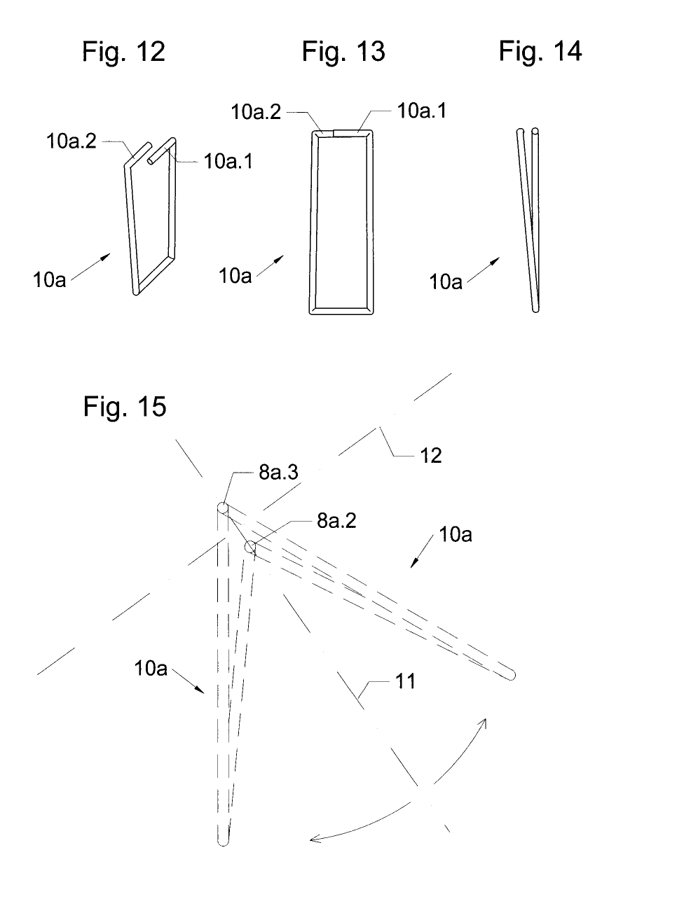

Referring now to FIG. 12-15, clip 10a is formed of resilient metal, such as spring steel, as a generally U-shaped frame, an end section of each of whose legs that is preferably shorter than the width of the frame is disposed inwardly, normal to the intended plane of motion of clip 10a, to form bearing journals 10a.1 and 10a.2.

Clip 10a is mounted to clip bearing 8a by inserting journals 10a.1 and 10a.2 to journal channels 8a.2 and 8a.3, respectively. FIG. 4, FIG. 7, and FIG. 8 depict clip 10a when mounted abutting back plate 2, an orientation termed hereafter the “default orientation”. Due to the axial offset of journal channels 8a.2 and 8a.3, clip 10a undergoes an elastic deformation when mounted in the default orientation—seen as a slight lateral skewing in FIG. 7—which induces structural stress. A restorative force is generated in turn, tending to relieve this stress, which force is manifested as a biasing torque urging the distal free end of clip 10a against backbone panel 2.

The degree of elastic deformation of clip 10a and, correspondingly, the magnitude of the attendant structural stress and biasing torque progressively increase as clip 10a is pivoted away from backbone panel 2, providing effective clasping of any thin-walled object, such as a garment edge, inserted therebetween.

The elastic deformation and structural stress of clip 10a reach a maximum when it is pivoted farther to an orientation of alignment with the plane defined by the axes of journal channels 8a.2 and 8a.3, represented by axis 11 in FIG. 15 and termed hereafter the “critical orientation”. The magnitude of the biasing torque reaches a maximum as the critical orientation is approached.

Pivoted farther, beyond the critical orientation, clip 10a reverts to a progressively lesser elastic deformation and structural stress, and the biasing torque, therefore, reverses its sense and its magnitude progressively diminishes.

Were clip 10a allowed to reach an orientation perpendicular to the critical orientation—an alignment represented by axis 12 in FIG. 15—elastic deformation and structural stress would vanish, as would the biasing torque. This orientation, however, cannot be reached due to range-limiting boss 8a.1 of clip bearing 8a. FIG. 9-11 depict clip 10a at this maximal angular displacement, hereafter termed the “prop orientation”.

When at the angular displacement of the critical orientation clip 10a is statically unstable. While it is subjected to no torque at that exact orientation, it is biased in the sense of decreasing angular displacement when at any lesser angular displacement and it is biased in the sense of increasing angular displacement when at any greater angular displacement. This behaviour facilitates the flipping of clip 10a from a clasping orientation to the prop orientation.

Clip 10a is so dimensioned that at the prop orientation, it may be used to prop PED holder inclined in a vertical (“portrait”) orientation or in a horizontal (“landscape”) orientation.

In preferred embodiments, backbone panel 2 and troughs 3 and 4 are advantageously rubberized, and clip 10a is at least partly sheathed in plastic, providing greater friction to better secure PED holder 1 to a clasped object, and increased traction to facilitate operation of a held PED when PED holder 1 is placed on a desktop or a similar horizontal surface by arresting movement of PED holder 1 upon such surface.

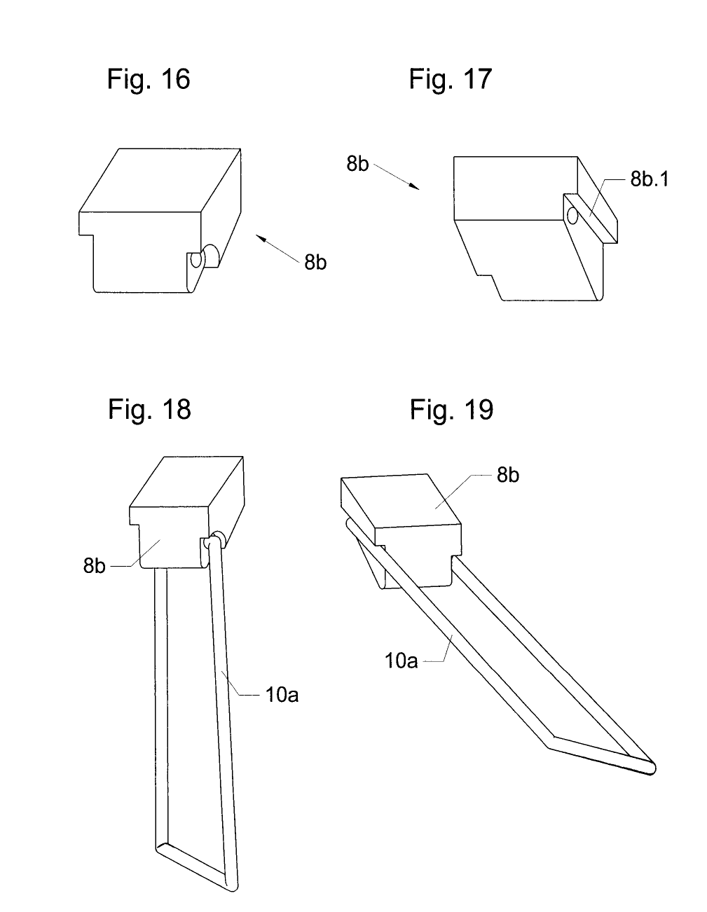

A second embodiment of the present invention employs an alternative to clip bearing 8a, denoted 8b and depicted isolated in FIG. 16 and FIG. 17. Clip bearing 8b is formed with a projecting ridge 8b.1 which limits the maximal angular displacement clip 10a may assume. Clip bearing 8b is depicted coupled to clip 10a in its default and prop orientations in FIG. 18 and FIG. 19, respectively. It will be clear to those skilled in the art that a wide range of bearing forms would be equally suitable to pivotally mount clip 10a and to define in an analogous manner the range of its possible angular displacement.

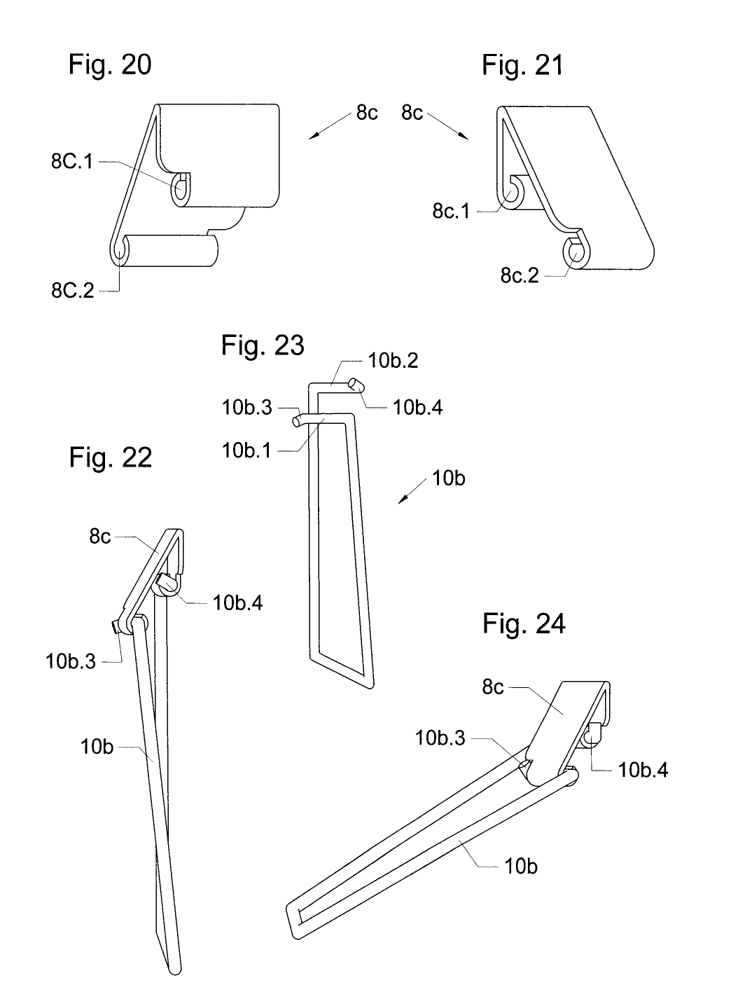

A third embodiment of the present invention employs an alternative form of clip 10a, depicted isolated in FIG. 23 and denoted 10b, and a second alternative to clip bearing 8a, depicted isolated in FIG. 20-21 and denoted 8c. Journal sections 10b.1 and 10b.2 of clip 10b are adapted with end stubs 10b.3 and 10b.4, extending perpendicularly in relation thereto at an orientation which imposes a limit to the maximal angular displacement clip 10b may assume when mounted to clip bearing 8c, as described below. Clip bearing 8c is formed of sheet metal defining two transverse, axially offset channels, 8c.1 and 8c.2, in which journals sections 10b.1 and 10b.2 of clip 10b are pivotally mounted so that extension stubs 10b.3 and 10b.4 are free to pivot outside of the respective channel. At the default orientation, shown in FIG. 22, extension stubs 10b.3 and 10b.4 play no role. When clip 10b is pivoted to a predetermined maximal angular displacement, however, extension stubs 10b.3 and 10b.4 come into contact with the body of clip bearing 8c, as seen in FIG. 24, preventing farther displacement.

1. A PED holder comprising
(a) a cradle, adapted to accommodate a PED of corresponding dimensionality and releasably secure it therewithin, permitting access to at least some of the controls and connection ports of said held PED and unobstructed viewing of its electronic visual display;
(b) a clip bearing, affixed to or formed with the rear face of said cradle, having two axially offset journal channels extending oppositely and transversely, partly or fully therethrough, their axes defining a plane inclined to the longitudinal axis of said cradle;
(c) a pivotable clip formed of resilient wire as an open frame, the transversely opposite end sections thereof being pivotally borne as bearing journals within the respective journal channels of said clip bearing, by which manner of mounting elastic structural deformation is sustained by said clip and a biasing torque ensues, urging said clip in the sense of decreasing angular displacement when below the plane defined by the axes of said journal channels, and in the sense of increasing angular displacement when above said plane.

2. The PED holder of claim 1, wherein said cradle comprises a backbone panel, extending from whose bottom and top ends are troughs in which the respective end of a PED to be held is received and resiliently clamped.

3. The PED holder of claim 2, wherein at least one of said troughs includes at least one leaf spring by which said resilient clamping action is exerted.

4. The PED holder of claim 2, wherein at least one of said troughs includes at least one length of high-resilience foam or elastomer by which said resilient clamping action is exerted.

5. The PED holder of claim 3 or 4, wherein said troughs are formed with inwardly sloping interior walls faces, thereby to guide the respective end of a PED to be held to a seated position.

6. The PED holder of claim 3, 4, or 5, wherein affixed to or integrated with the front face of said backbone panel is at least one spacer, formed as a shallow protuberance, by which protruding buttons of a PED seated with its buttons facing said backbone panel are accommodated.

7. The PED holder set forth in claim 2, wherein said backbone panel and said troughs are rubberized.

8. The PED holder set forth in claim 1 or 2, wherein said clip bearing, by its form or by a part or parts thereof, limits the range of orientations said clip may assume.

9. The PED holder set forth in claim 8, wherein said clip at its maximal angular displacement, by its form and dimension, may be used to prop said PED holder inclined on a substantially horizontal surface, in either a vertical (“portrait”) or a horizontal (“landscape”) orientation.

10. The PED holder set forth in claim 9, wherein said clip is at least in part sheathed in plastic.

11. The PED holder set forth in claim 8, wherein said clip bearing is formed as a block incorporating said journal channels or having said journal channels bored therein.

12. The PED holder set forth in claim 8, wherein said clip bearing is constructed of sheet metal as a bracket, two opposite edges thereof being rolled into cylindrical sleeves to serve as said journal channels;

13. The PED holder set forth in claim 12 wherein said clip is further adapted with end stubs extending perpendicularly from each of whose said journals at such an orientation that at a predetermined maximal angular displacement said end stubs come into contact with said sheet metal clip bearing, thereby preventing farther angular displacement of said clip.

14. A clip assembly comprising
(a) a clip bearing, integrated or adapted with two oppositely transverse and axially offset journal channels, extending partly or fully from either side therethrough on a plane inclined to its longitudinal axis, which clip bearing being further adapted or formed with a protruding part or parts which serve to limit the range of angular displacement of a pivotable arm borne therein;
(b) a pivotable arm formed of resilient wire as an open frame with oppositely transverse, possibly overlapping end sections functioning as bearing journals by which said arm is pivotally mounted to said clip bearing, due to which manner of mounting said arm sustains elastic structural deformation resulting in a biasing torque urging said arm towards a lesser angular displacement when oriented below the plane defined by the axes of said bearing journals, thereby to serve as a clasp, and towards a greater angular displacement when above said plane, thereby to readily assume the maximal angular displacement allowed, there to serve as a prop upon which to rest inclined an object with which said clip bearing is integrated or onto which it is affixed.

15. The clip assembly set forth in claim 14, wherein said bearing is formed as a block incorporating said journal channels or having said journal channels bored therein.

16. The clip assembly set forth in claim 14, wherein said bearing is constructed of sheet metal as a bracket, two opposite edges thereof being rolled into cylindrical sleeves to serve as said journal channels;

17. The clip assembly set forth in claim 16 wherein said clip is further adapted with end stubs extending perpendicularly from each of whose said journals at such an orientation that at a predetermined maximal angular displacement said end stubs come into contact with said sheet metal clip bearing, thereby preventing farther angular displacement of said clip.

18. The clip assembly set forth in claim 14, wherein said clip is at least in part sheathed in plastic.

19. The clip assembly set forth in claim 14, 15, or 17, wherein said object is a casing, housing, or cradle for releasably holding a portable electronic device.
